(19) United States
(12) Patent Application Publication
(10) Pub. No.: US 2013/0106269 A1
(43) Pub. Date: May 2, 2013

(54) SELF PACKAGING GRILL

(71) Applicants: Andrew Wolf Kahler, Fortson, GA (US); Curtis Harpe Pollock, Buena Vista, GA (US)

(72) Inventors: Andrew Wolf Kahler, Fortson, GA (US); Curtis Harpe Pollock, Buena Vista, GA (US)

(21) Appl. No.: 13/285,593

(22) Filed: Oct. 31, 2011

(51) Int. Cl. A47B 96/14; B65B 5/00; A47J 37/07

(52) U.S. Cl. 312/326; 312/351.1; 126/9 R; 53/467

(57) ABSTRACT

An appliance kit is disclosed. The kit includes an upper cabinet, and first and second support members. The first and second support members may be attached to the upper cabinet to place the appliance in operational form. The first and second support members are also used as structural support inside a shipping container for shipping the appliance, the first and second support members being located astride the upper cabinet to support the shipping container against crushing.

### BACKGROUND OF THE INVENTION

Large full sized gas grills normally consist of a firebox containing a cooking system, a lid that attaches to the firebox, side shelves that attach to the firebox and a frame that supports the firebox. These are normally shipped in corrugated cardboard boxes with supplemental expanded plastic foam pads for support and protection. The corners of the box may have corner posts to support vertical loads made of fiberboard or folded corrugated paper with structural properties approximating wood. Upon unpacking, the firebox and lid are often preassembled but the side shelves must be assembled to the firebox, the frame must be assembled, and the firebox set atop the frame. Often, formed steel angles and channels are mated with flat sheets of steel to form a stressed structure to support the firebox. The firebox normally is made of sheet steel or cast aluminum and is attached to the frame structure directly or through intermediate brackets with the use of threaded fasteners.

There are several significant shortcomings to the current art. The first of these has to do with the assembly of the grill at point of sale or point of use. The majority of grills are shipped in a partially or nearly completely disassembled configuration. Assembly of major components and even subassemblies may be required. Often the number of parts needed to be assembled is considerable and requires a large array of different types of fasteners leading to prolonged time required for assembly.

The second shortcoming is that the package required to ship the grill components must perform two distinct roles. It must contain and protect the subassemblies and components, and it must support the weight of several packages being stacked atop each other for shipment and storage in the product distribution system. This is normally done by use of corrugated paper products (e.g., cardboard). Sheets of cardboard may be used having multiple flutes and sheets engineered to carry out the two roles by itself, or cardboard may be used in conjunction with corner posts mentioned above. However, such material can lose up to 30% of its strength with storage in high humidity conditions, requiring significant overdesign and additional material with associated costs and environmental impact. A third shortcoming of the traditional methods is that the traditional grill subassemblies and components do not form an inherently rigid structure, and most assembled grills demonstrate some perceptible deflection of structure under even moderate loads.

What is needed is a system and method to address the above, and related, concerns.

### SUMMARY OF THE INVENTION

The invention of the present disclosure, in one embodiment thereof, comprises an appliance kit. The kit includes an upper cabinet, and first and second support members. The first and second support members may be attached to the upper cabinet to place the appliance in operational form. The first and second support members are also used as structural support inside a shipping container for shipping the appliance, the first and second support members being located astride the upper cabinet to support the shipping container against crushing.

In some embodiments, the upper cabinet is the firebox of a cooking grill. In some embodiments, the first and second support members further comprise first and second portions, respectively, of a lower cabinet that, when placed astride the upper cabinet in the shipping container, provides support against lateral loads on sides of the shipping container. The first portion of the lower cabinet may be preassembled with at least one attached door. A shelf unit may also be included that fits into the lower cabinet when assembled, and rests upon the upper cabinet in the shipping container providing resistance against damage to the cabinet. Also included with the kit may be a set of wheels that are attachable to the lower support members when attached to the upper cabinet to mobilize the assembled kit.

The first and second support members comprise frames constructed from tubular steel members. The kit may include a plurality of connectors used for joining the first and second support members together to construct a lower cabinet. At least one of the plurality of fasteners may comprise a threaded member that inserts partially into a first receiving end of one of the tubular steel members of the first support member, and inserts partially into a second receiving end of one of the tubular steel members of the second support member, the threaded member providing a first threaded connection adjacent an opening in the first receiving end and a second threaded connection adjacent an opening in the second receiving end, the first and second threaded connections accepting first and second threaded fasteners for retaining the first and second receiving ends to the threaded member.

The shipping container may be configured to at least partially surround the first and second support members protecting the first and second support members from abrasion damage during shipping and handling. The shipping container may comprise a cardboard structure internally supported by the first and second support members. The kit may also include a lower guide member having a surface contoured to locate the upper cabinet and the first and second support members in a predetermined relationship for packaging. A lower platform may also be included for supporting the lower guide member and providing a rigid bottom side of a shipping container.

The invention of the present disclosure, in another embodiment thereof, comprises a method of shipping an appliance. The method includes providing an appliance, providing first and second support members that may be assembled into a cabinet for supporting the appliance, and arranging the first and second support members around the appliance in a predetermined relationship inside a shipping container, the predetermined relationship of the first and second support members preventing crush damage to the appliance inside the shipping container.

In some embodiments, the method includes providing a lower guide member in the shipping container, the lower guide member having a surface contour corresponding to correct placement of the first and second guide members relative to the appliance to prevent damage to the appliance inside the shipping container. The method may also include providing a shelf that may be placed in the cabinet when assembled, and placing the shelf atop the appliance in the shipping container to prevent damage to the container from a high pressure point.

### BRIEF DESCRIPTION OF THE DRAWINGS

FIG. 1 is an exploded perspective view of a frame assembly according to aspects of the present disclosure.

FIG. 2A is an exploded inferior perspective view of a portion of the frame assembly of FIG. 1.

FIG. 2B is an assembled view of the illustration of FIG. 2A.

FIG. 3 is a perspective view of an assembled grill appliance utilizing the frame assembly of FIG. 1.

FIG. 4 is an exploded perspective view of a disassembled appliance utilizing an included support cabinet as support for its own shipping container.

FIG. 5 is a more detailed exploded perspective view of a disassembled appliance utilizing an included support cabinet as support for its own shipping container.

### DETAILED DESCRIPTION OF THE PREFERRED EMBODIMENTS

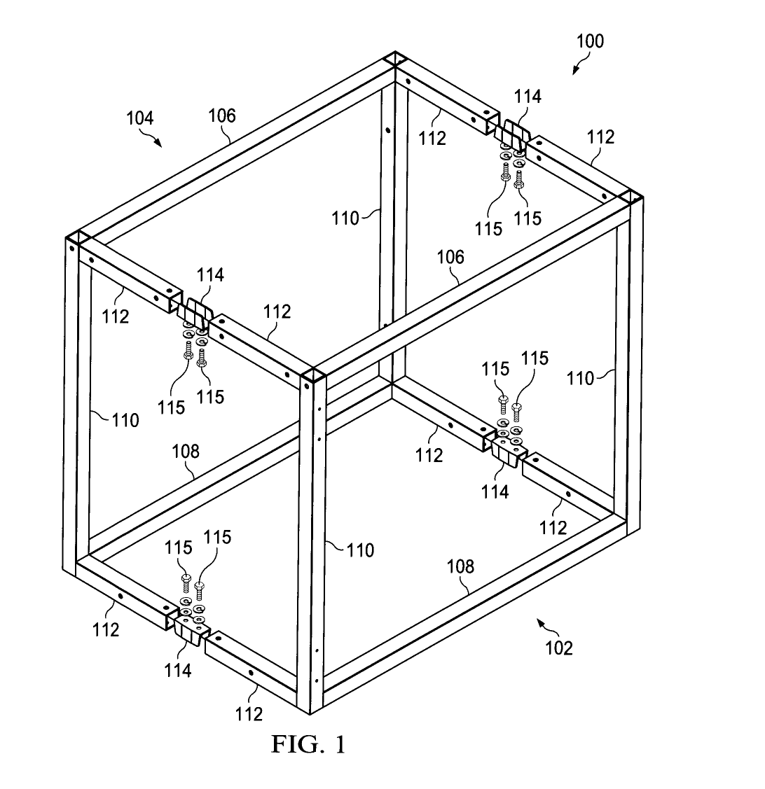

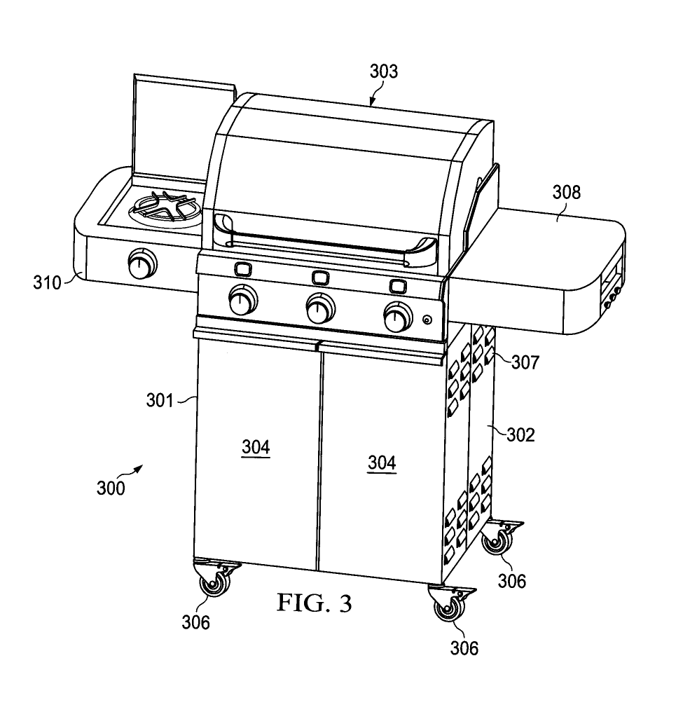

Referring now to FIG. 1, an exploded perspective view of a frame assembly 100 according to aspects of the present disclosure is shown. The frame assembly 100 of the present embodiment includes two major portions that serve as the basis for a lower support cabinet (300, FIG. 3) as described more fully below. The frame assembly includes a front subframe 102 and a rear subframe 104. Each of the subframes 102, 104 may include various support members arranged in a generally orthogonal fashion. For example, each of the subframes 102, 104 includes an upper lateral member 106 and a lower lateral member 108. Adjoining at right angles to these members are upright members 110. The front subframe 102 includes a plurality of connecting members 112 proceeding generally toward the rear subframe 104. Correspondingly, the rear subframe 104 includes a plurality of connecting members 112 proceeding generally toward the front subframe 102.

The subframes 102, 104 and each of the various constituent members may be made from welded tubular steel. In other embodiments, the tubular members may be bolted together or fastened by some other means. It is also contemplated that, in some embodiments, at least a portion of the front subframe 102 and/or rear subframe 104 may comprise a durable polymer.

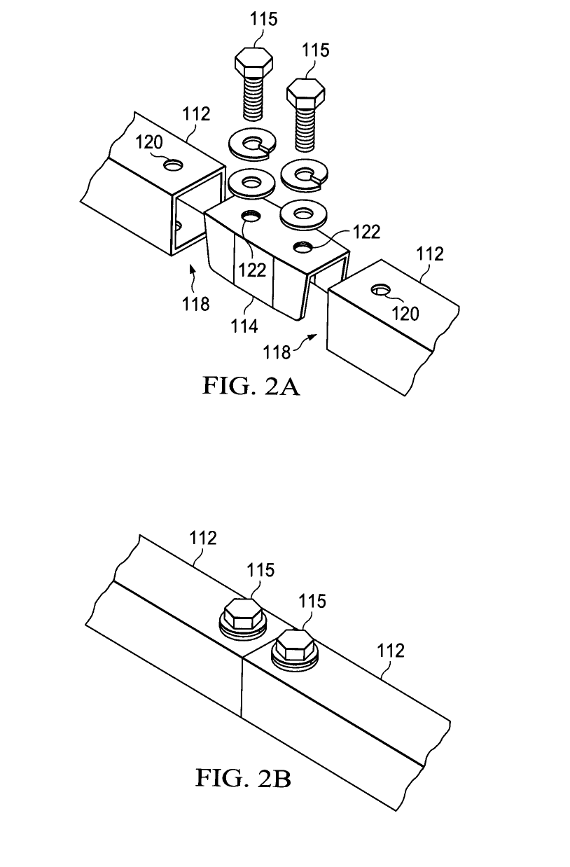

In the present embodiment, four connectors 114 serve to selectively attach the front subframe 102 to the rear subframe 104. When the front subframe 102 and rear subframe 104 are adjoined via the connectors 114, bolts 115 may be used to finalize the connection and complete construction of the frame 100. Referring now also to FIG. 2A, an exploded inferior perspective view of a portion of the frame assembly of FIG. 1 is shown. In FIG. 2A, additional detail is provided regarding the fitment of the front subframe 102 to the rear subframe 104. It can be seen that each of the connecting members 112 has a receiving end 118 into which the connector 114 fits in a slidable fashion. The connector 114 may be a bent segment of metal or polymer sized to fit within the respective openings 118. In the present embodiment, the connector 114 defines threaded openings 122. These threaded openings 122 correspond to openings 120 and the connecting members 112. In other embodiments, the connector 114 may employ a captive fastener rather than a threaded opening 122.

Referring now also to FIG. 2B, it can be seen that when the ends 118 are joined together over the connector 114, the bolts 115 may be inserted to secure the two connecting members 112 together. It will be appreciated that, by completing this process with respect to all four corners of the frame 100, the front subframe 102 and rear subframe 104 may be completely fastened together, forming the basis of the lower support cabinet 300.

Referring now to FIG. 3, a perspective view of an assembled grill appliance utilizing the frame assembly of FIG. 1 is shown. It can be seen that, once the frame 100 is assembled, various coverings may be provided that give the frame 100 the appearance and function of a lower cabinet 300. It can also be seen that the front subframe 102 and the rear subframe 106 form a front support member 301 and a rear support member 302, respectively. It will also be appreciated that the frame 100 and/or front and rear subframes 102, 104 need not necessarily be bare when assembled. For example, as long as the ends 118 of the connecting members 112 are accessible, the front subframe 102 and rear subframe 104 can be assembled prior to being joined together.

When the front and rear support members 301, 302 made from the front and rear subframes 102, 104 are joined together to complete the cabinet 300, the cabinet 300 may be used to support an appliance 303 at a useful height. In the present embodiment, the appliance 302 is a cooking grill. However, in other embodiments, the appliance could be another useful device that a user might prefer to have at a taller height, and which would benefit from the packing methods described below. In one respect, the grill or appliance 303 may be considered as an upper cabinet positioned on the lower cabinet 300.

As the supported appliance, or upper cabinet 303, in the present embodiment is a cooking grill, the frame lower cabinet 300 is shown assembled into a storage cabinet accessible via doors 304. Ventilation louvers 307, as well as other utilitarian and/or decorative features may also be provided on the frame cabinet 300. The present embodiment also includes a side shelf 308 and a side burner 310. It is understood that these items are provided only for illustration as other accessories and implements could also be attached to the grill 302 and/or frame lower cabinet 300.

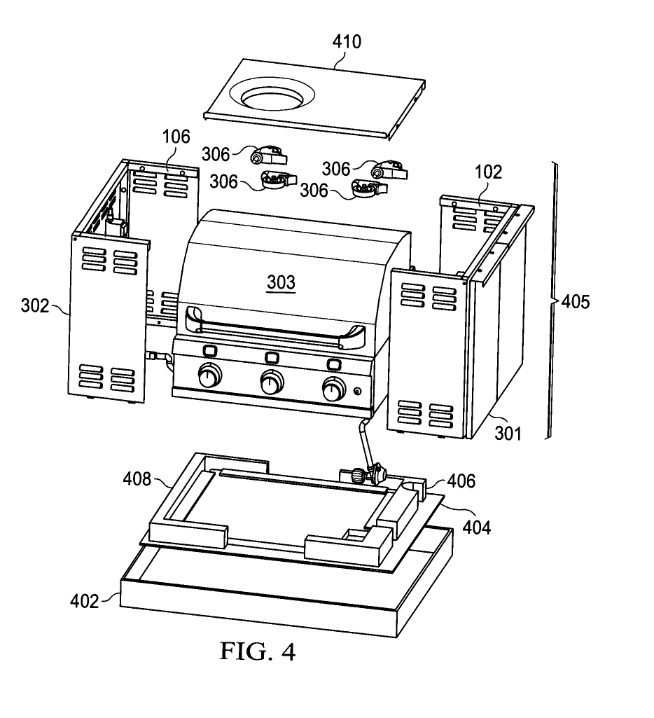

Referring now to FIG. 4, an exploded perspective view of a disassembled appliance utilizing an included support cabinet as support for its own shipping container is shown. Here, it can be seen that the frame or cabinet 300 has been disassembled into the front lower support member 301 and the rear lower support member 302. As described above, in some embodiments the front and rear lower support members 301, 302 are packed and shipped in a substantially intact configuration as shown. The respective frames 102, 106 serves as rigid attachment points for covers, panels, and doors 304. The doors 304 may be shipped attached to the frame 102. This prevents user error and frustration in having to attach doors 304 upon unpacking. In the present embodiment, pre-attached doors 304 are one benefit of splitting the lower cabinet 300 into front and rear support members 301, 302, rather than dividing it laterally.

In the present embodiment, a portion of a shipping container is shown as a lower platform 402. The lower platform 402 may comprise a rigid or resilient structure, capable of being moved by a forklift without damage, for example. In addition to the lower platform 402, a lower guide member 404 may be provided. The contour of the surface of lower guide member 404 may include features that aid in retaining the appliance 303, and front and rear support members 301, 302 in a predetermined location relative to one another.

When placed in the configuration shown in preparation for shipping, the various components such as the appliance 303 and the front and rear support members 301, 302, may be considered a shipping unit 405. In the present embodiment, the lower guide member 404 provides a front wall 406 designed to fit against the front support member 301 and a portion of the grill 303. The lower guide member 404 also has a rear wall 408 designed to fit against the rear support member 302 and a portion of the grill 303. Also shown as part of the shipping unit in the present embodiment are the removable wheels 306 and a shelf 410. The shelf 410 may be utilized within the cabinet 300 formed by the front and rear support members 102, 104.

With reference back to FIG. 3, it can be seen that, when the front and rear support members 301, 302 are assembled into the lower cabinet 303, the front support member 301 would face the front of the grill 303 with the doors 304 on the front as well. Additionally, the rear support member 302 would be located on the rear side of the grill 303. With reference to FIG. 4, it can be seen that in some embodiments, the front support member 301 and the rear support member 302 may be rotated with respect to the grill 303 approximately 90 degrees. This allows the front and rear support members 301, 302, when configured as a shipping unit 405, to be able to protect the grill 302 from crush damage, even though, when assembled as the completed lower cabinet 300, they may have substantially the same footprint as the grill 302. Additionally, the structure of the front and rear support members 301, 302 may protect items packed as part of the shipping unit 405 against a certain amount of damage from single high pressure points, such as bumps by forklifts or other dock equipment.

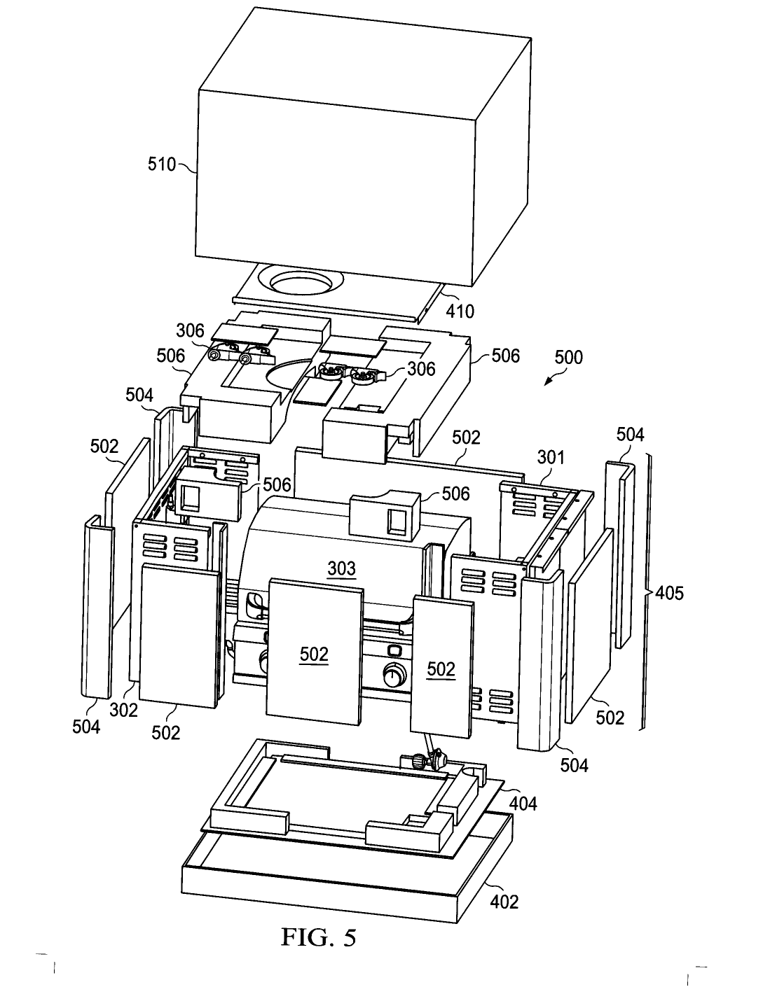

Referring now to FIG. 5, another exploded perspective view of a disassembled appliance utilizing its own cabinet for support in a shipping container is shown. FIG. 5 illustrates additional detail and packing material. Here, all of the components of the shipping unit 405 are shown with respect to the entirety of the associated shipping container. In the present embodiment, the shipping container includes the lower platform 402, the lower guide member 404, as well as various pieces of auxiliary impact protective packing material 502. These may be made of Styrofoam®, cardboard, or another inexpensive packing material. The shipping container may also comprise corner pieces 504 that may be made of cardboard, wood, Styrofoam®, or another impact resistant material. Internal spacing material 506 may also be included to help insure that the shipping unit 405 remains in proper relative position with respect to its constituent pieces. Finally, an outer covering 510 may be provided that aids in holding the shipping unit 405 and other pieces of the shipping container in place.

In the present embodiment, the outer covering 510 is shown as a component that slides down over the pieces it contains, and attaches to the lower platform 402. However, it is understood that the outer covering may also be pre-attached to the lower platform 402, and the shipping unit 405 may be inserted through the top. The outer covering 510 may be cardboard or another inexpensive material. When the shipping container and the shipping unit 405 are assembled for shipment, it can be appreciated that the front and rear support members 301, 302 define a region inside the shipping container that will be protected from crushing forces. In this manner, the pieces of the shipping container itself may be made lighter and thinner, and therefore less expensive, while the front and rear support members 301, 302 of the cabinet 300 of the appliance 303 serve as internal structure. Once the shipping container arrives at its final destination, there will be relatively less waste material to discard when the appliance 303 is placed into operation.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the invention as defined by the claims.

What is claimed is:

1. An appliance kit comprising:
an upper cabinet; and
first and second support members;
wherein the first and second support members may be attached to the upper cabinet to place the appliance in operational form; and
wherein the first and second support members are used as structural support inside a shipping container for shipping the appliance, the first and second support members being located astride the upper cabinet to support the shipping container against crushing.

2. The appliance kit of claim 1:
wherein the first and second support members further comprise first and second portions, respectively, of a lower cabinet that, when placed astride the upper cabinet in the shipping container, provides support against lateral loads on sides of the shipping container; and
wherein the first portion of the lower cabinet is preassembled with at least one attached door.

3. The appliance kit of claim 2, further comprising a shelf unit that fits in the lower cabinet when assembled, and rests upon the upper cabinet in the shipping container providing resistance against damage to the cabinet.

4. The appliance kit of claim 1, wherein the first and second support members comprise frames constructed from tubular steel members.

5. The appliance kit of claim 4, further comprising a plurality of connectors used for joining the first and second support members together to construct a lower cabinet.

6. The appliance kit of claim 5, wherein at least one of the plurality of fasteners comprises a threaded member that inserts partially into a first receiving end of one of the tubular steel members of the first support member, and inserts partially into a second receiving end of one of the tubular steel members of the second support member, the threaded member providing a first threaded connection adjacent an opening in the first receiving end and a second threaded connection adjacent an opening in the second receiving end, the first and second threaded connections accepting first and second threaded fasteners for retaining the first and second receiving ends to the threaded member.

7. The appliance kit of claim 1, wherein the shipping container at least partially surrounds the first and second support members protecting the first and second support members from abrasion damage during shipping and handling.

8. The appliance kit of claim 7, wherein the shipping container comprises a cardboard structure internally supported by the first and second support members.

9. The appliance kit of claim 1, further comprising a lower guide member having a surface contoured to locate the upper cabinet and the first and second support members in a predetermined relationship for packaging.

10. The appliance kit of claim 9, further comprising a lower platform supporting the lower guide member and providing a rigid bottom side of a shipping container.

11. The appliance kit of claim 1, wherein the upper cabinet comprises a firebox of a cooking grill.

12. The appliance kit of claim 1, further comprising a set of wheels that are attachable to the lower support members when attached to the upper cabinet to mobilize the assembled kit.

13. An appliance kit comprising:
an appliance;
first and second lower support members that may be attached together as front and back halves, respectively, of a lower cabinet and support the appliance at a predetermined height; and
wherein the first and second support members comprise steel frames that are at least as tall as the appliance;
wherein the appliance may be placed between the first and second support members to create a shipping unit, the shipping unit providing its own support against crushing inside a shipping container.

14. The appliance kit of claim 13, wherein the first and second lower support members attach together to create a cabinet for supporting the appliance, the cabinet having a substantially rectilinear shape, and the first and second lower support members defining a substantially rectilinear shipping unit when so arranged relative to the appliance to prevent crushing inside the shipping container.

15. The appliance kit of claim 14, wherein the first and second support members are arranged at a first predetermined angle axially relative to the appliance when joined to form the cabinet, and are arranged about 90 degrees offset from the first predetermined angle axially relative to the appliance when arranged so as to faun the shipping unit.

16. The appliance kit of claim 13, further comprising a plurality of connectors for attaching the first and second lower support members together, the connectors comprising a plurality of threaded connections for attaching to the first and second lower support members with a threaded fastener.

17. The appliance kit of claim 13, wherein the first support member is preassembled with at least one cabinet door.

18. A method of shipping an appliance comprising:
providing an appliance;
providing first and second support members that may be assembled into a cabinet for supporting the appliance; and
arranging the first and second support members around the appliance in a predetermined relationship inside a shipping container, the predetermined relationship of the first and second support members preventing crush damage to the appliance inside the shipping container.

19. The method of claim 18, further comprising providing a lower guide member in the shipping container, the lower guide member having a surface contour corresponding to correct placement of the first and second guide members relative to the appliance to prevent damage to the appliance inside the shipping container.

20. The method of claim 18, further comprising:
providing a shelf that may be placed in the cabinet when assembled, and
placing the shelf atop the appliance in the shipping container to prevent damage to the container from a high pressure point.
